(19) United States
(12) Patent Application Publication
(10) Pub. No.: US 2022/0169243 A1
(43) Pub. Date: Jun. 2, 2022

(54) REVERSE OPERATION DETECTION SYSTEMS AND METHODS

(71) Applicant: GM GLOBAL TECHNOLOGY OPERATIONS LLC, Detroit, MI (US)

(72) Inventors: Mohammad Naserian, Windsor (CA); Feiyu Cong, Shanghai (CN); Jie Zhu, Shanghai (CN); Curtis L. Hay, Washington Twp, MI (US); Priya B. Abraham, Sterling Heights, MI (US)

(73) Assignee: GM GLOBAL TECHNOLOGY OPERATIONS LLC, Detroit, MI (US)

(21) Appl. No.: 17/110,283

(22) Filed: Dec. 2, 2020

(51) Int. Cl. B60W 30/095; B60W 40/04; B60W 40/105; H04W 4/40

(52) U.S. Cl. CPC B60W 30/0956; B60W 40/04; B60W 40/105; B60W 2556/45; B60W 2554/4044; B60W 2520/06; B60W 2555/60; H04W 4/40

(57) ABSTRACT

Systems and method are provided for notifying an operator of a vehicle of reverse operation of a vehicle. In one embodiment, a method includes: determining, by a processor, reverse direction operation of a first vehicle on a road; selectively generating, by a processor, notification data based on the reverse operation, map data, camera data, and speed data, wherein the notification data includes information to notify an operator of a second vehicle of the reverse operation; and selectively generating, by a processor, communication data based on the reverse operation, wherein the communication data includes information to notify at least one of a third vehicle and a remote transportation system of the reverse direction operation.

### INTRODUCTION

The present disclosure generally relates to vehicles, and more particularly relates to systems and methods for detecting reverse driving operation of a vehicle.

Most all vehicles are capable of driving in a forward and a reverse direction. Typically, vehicle operators operate the vehicle in a forward direction on a road. In some instances, a vehicle operator chooses to operate the vehicle in a reverse direction on the road. For example, when the operator misses an exit on a highway, the operator my choose to stop and operate the vehicle in a reverse direction toward the missed exit. Such operation along the road is undesirable as it may cause disruption to the flow of traffic and/or a collision, and in many cases is unlawful.

Accordingly, it is desirable to provide methods and systems for detection of a vehicle operating in a reverse direction along a road. It is further desirable to provide methods and systems for notifying others of the reverse operation of a vehicle. Furthermore, other desirable features and characteristics of the present invention will become apparent from the subsequent detailed description and the appended claims, taken in conjunction with the accompanying drawings and the foregoing technical field and background.

### SUMMARY

Systems and method are provided for notifying an operator of a vehicle of reverse operation of a vehicle. In one embodiment, a method includes: determining, by a processor, reverse direction operation of a first vehicle on a road; selectively generating, by a processor, notification data based on the reverse operation, map data, camera data, and speed data, wherein the notification data includes information to notify an operator of a second vehicle of the reverse operation; and selectively generating, by a processor, communication data based on the reverse operation, wherein the communication data includes information to notify at least one of a third vehicle and a remote transportation system of the reverse direction operation.

In various embodiments, the method includes receiving a message indicating reverse operation of an other vehicle, and wherein the determining the reverse direction operation of the first vehicle is based on the message. In various embodiments, the method includes determining that the other vehicle is traveling on a same road as the second vehicle based on the map data, and wherein the selectively generating the notification data is based on the determining. In various embodiments, the selectively generating the notification data includes determining that the other vehicle is traveling ahead of the second vehicle based on the map data, and wherein the selectively generating the notification data is based on the determining.

In various embodiments, the selectively generating the notification data includes determining that the speed limit of the road is above a threshold.

In various embodiments, the method includes detecting reverse direction operation of the first vehicle based on a transmission state of the first vehicle, and a speed of the first vehicle, and wherein the determining the reverse direction operation is based on the detection. In various embodiments, the first vehicle and the second vehicle are the same vehicle. In various embodiments, the method includes determining that the speed limit of the road is above a threshold, and wherein the determining the reverse direction operation is based on the determining.

In various embodiments, the method includes communicating the communication data to the remote transportation system.

In various embodiments, the method includes communicating the communication data to the third vehicle.

In another embodiment, a computer implemented system includes a reverse direction detection module that includes one or more processors configured by programming instructions encoded in non-transitory computer readable media. The reverse direction detection module is configured to: determine reverse direction operation of a first vehicle on a road; selectively generate notification data based on the reverse operation, map data, camera data, and speed data, wherein the notification data includes information to notify an operator of a second vehicle of the reverse operation; and selectively generate communication data based on the reverse operation, wherein the communication data includes information to notify at least one of a third vehicle and a remote transportation system of the reverse direction operation.

In various embodiments, the reverse direction detection module is further configured to receive a message indicating reverse operation of another vehicle, and wherein the determining the reverse direction operation of the first vehicle is based on the message. In various embodiments, the reverse direction detection module is further configured to determine that the other vehicle is traveling on a same road as the second vehicle based on the map data, and selectively generate the notification data based on the determination. In various embodiments, the reverse direction detection module is configured to selectively generate the notification data by determining that the other vehicle is traveling ahead of the second vehicle based on the map data, and generate the notification data based on the determination.

In various embodiments, the reverse direction detection module is configured to selectively generate the notification data by determining that the speed limit of the road is above a threshold, and generate the notification data based on the determination.

In various embodiments, the reverse direction detection module is further configured to detect reverse direction operation of the first vehicle based on a transmission state of the first vehicle, and a speed of the first vehicle, and determine the reverse direction operation based on the detection. In various embodiments, the first vehicle and the second vehicle are the same vehicle.

In various embodiments, the reverse direction detection module is further configured to determine that the speed limit of the road is above a threshold, and determine the reverse direction operation based on the determination.

In various embodiments, the reverse direction detection module is further configured to communicate the communication data to the remote transportation system.

In various embodiments, the reverse direction detection module is further configured to communicate the communication data to the third vehicle.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating a vehicle having a reverse direction detection system, in accordance with various embodiments;

FIG. 2 is functional block diagram illustrating an operating environment of a vehicle and having the reverse direction detection system, in accordance with various embodiments;

FIG. 3 is a dataflow diagram illustrating a reverse direction detection module, in accordance with various embodiments;

FIGS. 4-6 illustrate embodiments of the reverse direction detection module, in accordance with various embodiments; and

FIGS. 7 and 8 are flowcharts illustrating reverse direction detection methods that may be performed by the reverse direction detection system, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

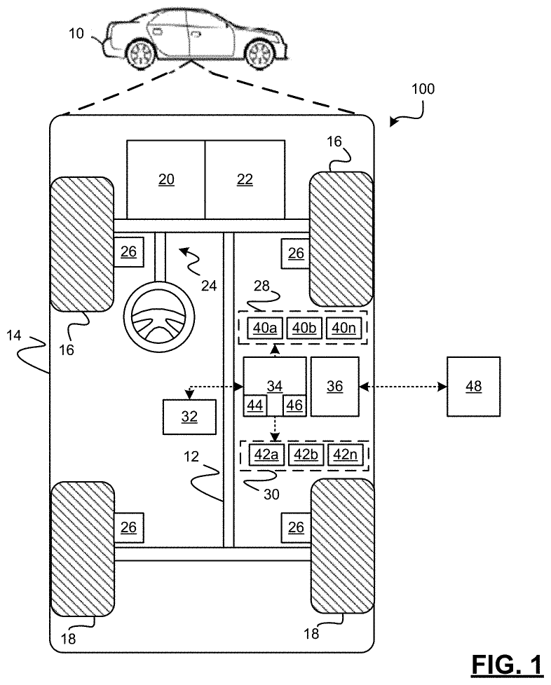

With reference to FIG. 1, a reverse direction detection system shown generally at 100 is associated with a vehicle 10 in accordance with various embodiments. In general, the reverse direction detection system 100 receives and processes sensor data, map data, vehicle to everything communications (V2X), and/or vehicle to vehicle communications (V2V) to determine when the vehicle 10 is operating in a reverse direction along a road and warn operators of other vehicles to take appropriate action.

As depicted in the example of FIG. 1, the vehicle 10 is an automobile and generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

As shown, the vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20, in various embodiments, includes an internal combustion engine, an electric machine, such as a traction motor powered by one or more batteries, alone (e.g., as a pure electric vehicle) or in combination with an internal combustion engine, and/or a fuel cell propulsion system (e.g., as a hybrid electric vehicle).

The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18.

The sensor system 28 includes one or more sensing devices 40a-40n that sense observable conditions of the exterior environment and/or the interior environment of the vehicle 10. The sensing devices 40a-40n can include, but are not limited to, radars, lidars, global positioning systems, optical cameras, thermal cameras, ultrasonic sensors, inertial measurement units, and/or other sensors. In various embodiments, the sensor system 28 further includes one or more sensing devices 41a-41n that sense observable conditions of one or more vehicle components. For example, one or more of the sensing device 41a-41n sense a transmission range or state, and a vehicle speed. The sensor measurements are then used to determine when the vehicle 10 is operating in a reverse direction.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

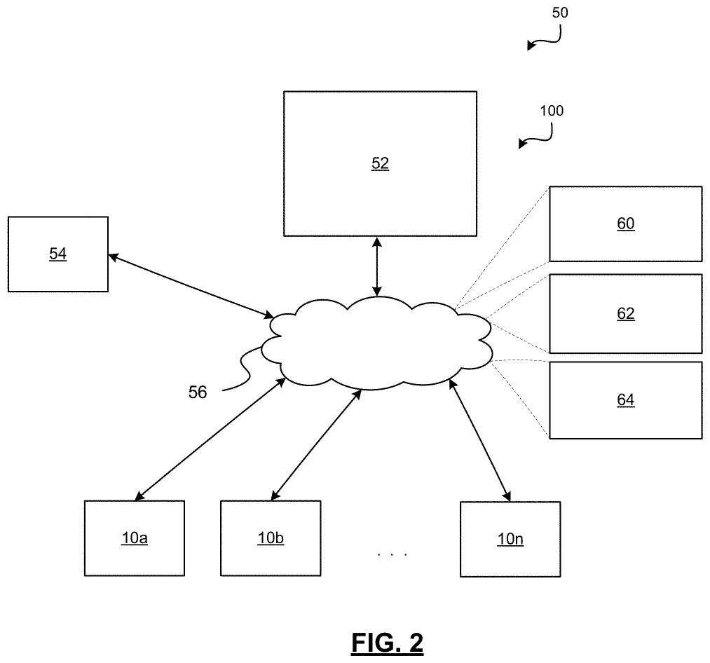

The communication system 36 is configured to wirelessly communicate information to and from other entities 48, such as but not limited to, other vehicles (“V2V” communication) infrastructure (“V2I” communication), everything (“V2X” communication), remote systems, charging stations, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, LTE-V2X, C-V2X, are also considered within the scope of the present disclosure. DSRC channels refer to one-way or two-way short-range to medium-range wireless communication channels specifically designed for automotive use and a corresponding set of protocols and standards.

The data storage device 32 stores data for use in controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. Route information may also be stored within data storage device 32—i.e., a set of road segments (associated geographically with one or more of the defined maps) that together define a route that the user may take to travel from a start location (e.g., the user's current location) to a target location. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10. In various embodiments, the controller 34 is configured to implement reverse direction detection systems and methods as discussed in detail below.

In various embodiments, the instructions of the controller 34 may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to control features of the vehicle 10. As mentioned briefly above, all or part of the reverse direction detection system 100 of FIG. 1 is included within the controller 34.

With reference now to FIG. 2, where an operating environment of the reverse direction detection system 100 is shown generally at 50 that includes a remote transportation system 52 that is associated with and communicates with one or more vehicles 10a-10n as described with regard to FIG. 1. In various embodiments, the operating environment 50 further includes one or more user devices 54 that communicate with the vehicles 10a-10n and/or the remote transportation system 52 via a communication network 56.

The communication network 56 supports communication as needed between devices, systems, and components supported by the operating environment 50 (e.g., via tangible communication links and/or wireless communication links). For example, the communication network 56 can include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a piece of home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, which may be cloud-based, network-based, or resident at the particular campus or geographical location serviced by the remote transportation system 52. The remote transportation system 52 can be manned by a live advisor, or an automated advisor, or a combination of both. The remote transportation system 52 can communicate with the user devices 54 and/or the vehicles 10a-10n to schedule rides, dispatch vehicles 10a-10n, communicate information, and the like as will be discussed in more detail below.

As can be appreciated, the subject matter disclosed herein provides certain enhanced features and functionality to what may be considered as a standard or baseline vehicle 10 and/or remote transportation system 52. To this end, a vehicle and a remote transportation system can be modified, enhanced, or otherwise supplemented to provide the additional features of the reverse direction detection system 100 disclosed herein.

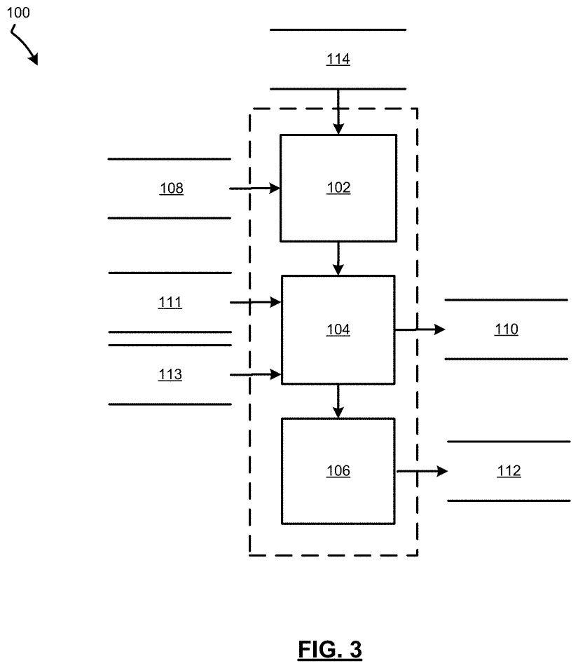

As shown in more detail with regard to FIG. 3 and with continued reference to FIG. 1, the reverse direction detection system 100 may be implemented as one or more modules configured to perform one or more methods by way of, for example, a processor. As can be appreciated, the modules shown in FIG. 3 can be combined and/or further partitioned in order perform the functions or methods described herein. Furthermore, inputs to the modules may be received from the sensor system 28, received from other control modules (not shown) associated with the vehicle 10, received from the communication system 36, and/or determined/modeled by other sub-modules (not shown) within the controller 34 of FIG. 1. Furthermore, the inputs might also be subjected to preprocessing, such as sub-sampling, noise-reduction, normalization, feature-extraction, missing data reduction, and the like.

In various embodiments, the reverse direction detection system 100 includes a reverse direction detection module 102, a notification module 104, and a communications module 106. The modules shown can be implemented on each of the vehicles 10a-10n and/or on the remote transportation system 52. For example, the reverse direction detection module 102 detects when a vehicle is operating in reverse based on vehicle operation data 108 indicating, for example, speed and transmission state. The notification module 104 selectively notifies or warns an operator of the vehicle via notification data 110 of the detected reverse operation based on map data 111 and/or camera data 113 (e.g., including images of traffic signs). The communications module 106 selectively communicates messages via message data 112 to the remote transportation system 52, the user devices 54, and/or the vehicles 10a-10n based on the reverse direction detection.

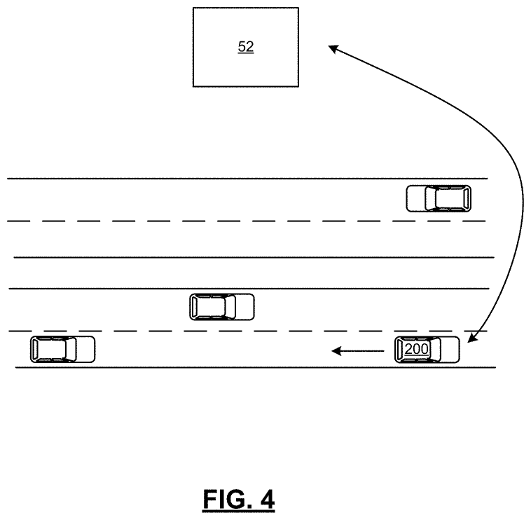

For example, FIG. 4 illustrates an embodiment of the reverse direction detection system 100 being implemented on a vehicle 200 and the remote transportation system 52, and the vehicle 200 detects its own reverse operation, self-reports the detection, and self warns of the danger of the operation. For example, as shown, the reverse direction detection module 102 of the vehicle 200 detects that the vehicle 200 is operating in reverse based on the vehicle operation data 108. The notification module 104 of the vehicle 200 identifies the location of the vehicle 200 to be on an expressway or other road with high speed traffic based on the map data 111 and/or camera data 113. The notification module 104 warns the operator (via the notification data 110) about the reverse maneuver. The communications module 106 reports the reverse operation to the remote transportation system 52 (via message data 112). If the vehicle is V2X equipped, the communications module 106 broadcasts standard messages (via message data 112) that includes the transmission state of the vehicle 200 as being reverse.

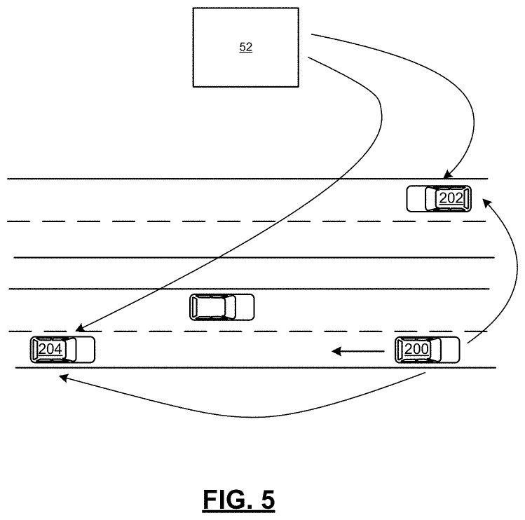

In another example, FIG. 5 illustrates an embodiment of the reverse direction detection system 100 being implemented on vehicle 200, 202, and 204 and the remote transportation system 52, and the vehicles 202, 204 receiving a message about reverse operation of the vehicle 200. For example, the reverse direction detection module 102 of the vehicle 204 receives the message broadcast from the vehicle 200 (via message data 114) and identifies that the vehicle 200 is reversing in its path. The notification module 104 of the vehicle 204 warns the operator of the vehicle 204 about the reverse operation in its path via the notification data 110. The communications module 106 of the vehicle 204 reports the location of the reverse operation to the remote transportation system 52 via message data 112.

In another example the reverse direction detection module 102 of the vehicle 202 receives the message broadcast from the vehicle 200 and identifies that the vehicle 200 is not reversing in its path. The communications module 106 reports the location of the reverse operation of vehicle 200 to the remote transportation system 52 via message data 112.

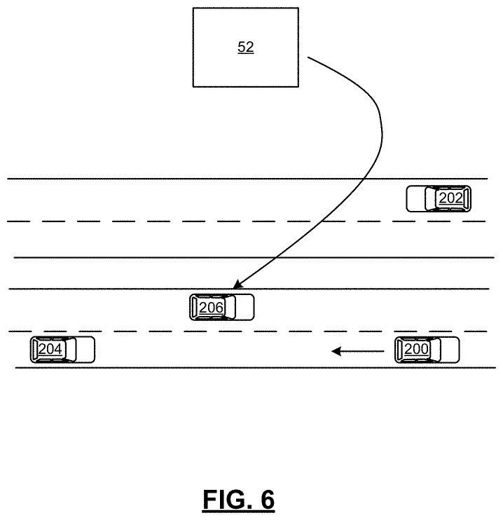

FIG. 6 illustrates an embodiment of the reverse direction detection system 100 being implemented on vehicle 206 and the remote transportation system 52, and the remote transportation system 52 detects the reverse operation, reports to other vehicles 206, and the vehicles 206 warn their operators.

For example, the reverse direction detection module 102 of the remote transportation system 52 receives a message indicating reverse operation from one or more of the vehicles 200-204. The communications module 106 of the remote transportation system 52 pushes messages via message data 112 indicating the reverse operation to relevant vehicles 206 in the area of the reverse operation.

The notifications module of the vehicle 206 receives the message indicating the reverse operation and warns the operator about the reverse operation in the path of the vehicle 206 via notification data 110.

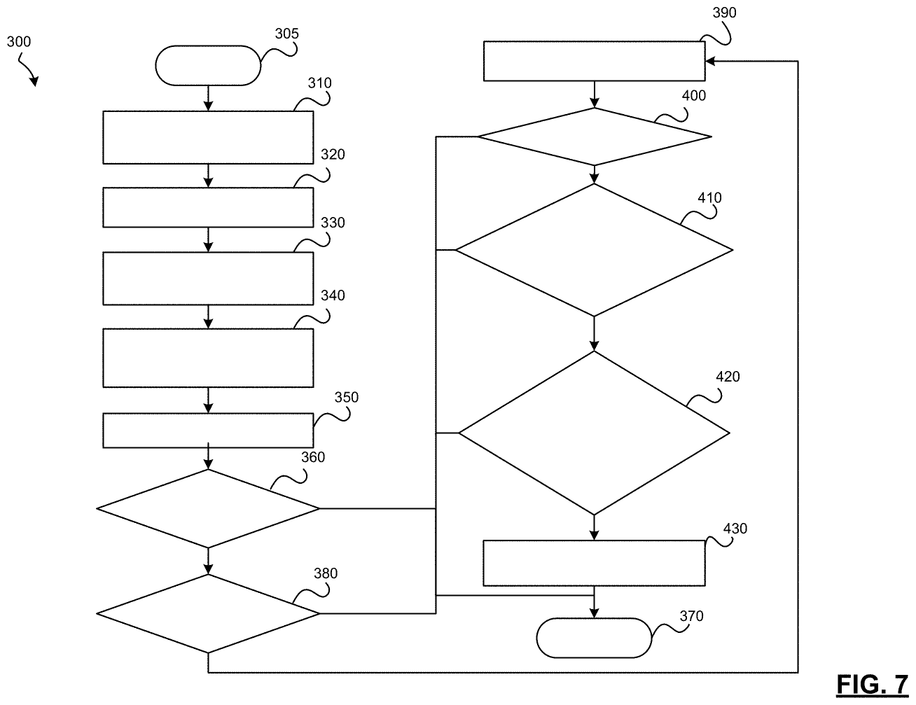

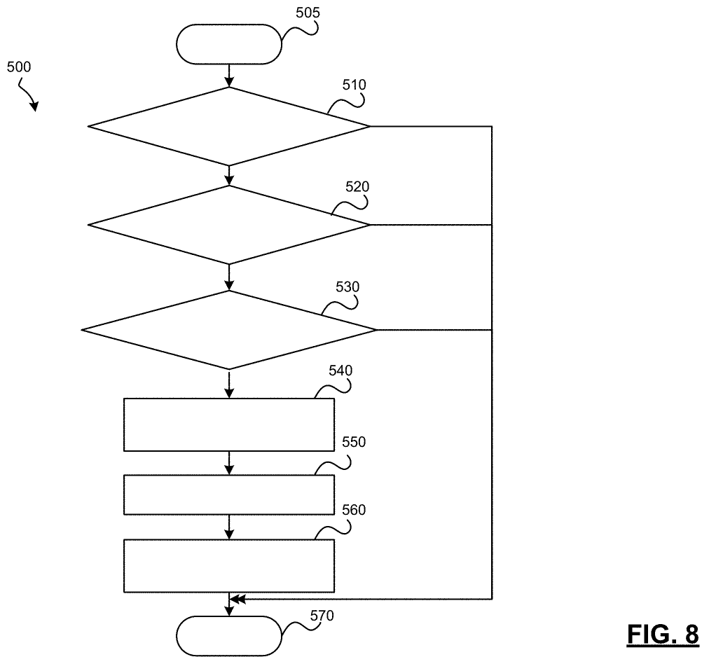

Referring now to FIGS. 7 and 8, and with continued reference to FIGS. 1-6, flowcharts illustrate methods 300, 500 that can be performed by the reverse direction detection system 100 of FIGS. 1-6 in accordance with the present disclosure. As can be appreciated in light of the disclosure, the order of operation within the methods is not limited to the sequential execution as illustrated in FIGS. 7 and 8 but may be performed in one or more varying orders as applicable and in accordance with the present disclosure. In various embodiments, the methods 300 and 500 can be scheduled to run based on one or more predetermined events, and/or can run continuously during operation of the vehicle 10 or the remote transportation system 52.

In various embodiments, the method 300 may begin at 305. Thereafter, at 310, a message is received at a vehicle indicating reverse operation of another vehicle. The latitude and longitude of the vehicle (HV) and the other vehicle (RV) is converted to Earth Centered Earth Fixed (ECEF) coordinates (X_ECEF, Y_ECEF, Z_ECEF) at 320. The ECEF coordinates for all the RVs are converted to East North Up (ENU) coordinates (X_ENU, Y_ENU) at 330. The RVs global coordinate system is rotated in relation to the HVs heading at 340. The location, path history, and heading is then used to classify the RV in respect to the HV as: ahead, behind, intersecting, oncoming, left side, right side at 350.

The RV's transmission state and speed are then verified at 360. For example, if the RVs transmission state is not reverse or the RV's speed is zero, the method 300 may end at 370. If the RVs transmission state is reverse and the RV's speed is greater than zero, the map data is evaluated to determine if the RV is on a road with a speed limit higher than a threshold at 380 and if so, the RV is reported as a reverse operation to the remote transportation system 52 at 390.

If the RV is classified as ahead of the HV at 400, the difference between the HV and the RV elevation is compared to an elevation threshold and/or map matching is used to determine if the RV and the HV are on the same road at 410. If the RV and the HV are not on the same road at 410, the method may end at 370. If, however, the RV and the HV are traveling on the same road at 410, the operating conditions of the HV and the RV are evaluated at 420. For example, if the HV transmission state is drive, the HV speed is greater than a threshold, and the RV reverse speed is greater than a threshold, and the distance to the RV is less than a distance threshold, and the time to the RV is less than a time threshold at 420, the notification is generated to notify the operator of the HV of the reverse operation of a vehicle ahead at 430. Thereafter, the method 300 may end at 370.

If the HV transmission state is not drive, the HV speed is not greater than a threshold, the RV reverse speed is not greater than a threshold, the distance to the RV is not less than a distance threshold, or the time to the RV is not less than a time threshold, the method 300 may end at 370 without reporting.

In various embodiments, the method 500 may begin at 505. Thereafter, the HVs transmission state and speed are evaluated at 510 and reverse operation on a highspeed road is confirmed at 520-530. For example, if the HVs transmission state is reverse and the HVs speed is greater than zero at 510, then the road conditions are evaluated at 520-530. For example, if the map data and/or camera data (e.g., including captured road signs) indicates that the vehicle is on an expressway or other fast speed road at 520, it is concluded that the HV is operating on a fast speed road and the notification is generated to notify the operator of the HV of the reverse operation of the vehicle at 540. Additionally or alternatively, the history of vehicle movement just before and after the transmission state change is evaluated at 530 looking for specific patterns such as, but not limited to, the HV travelling at speed above a threshold (e.g. 40 mph) for TBD seconds, the operator applies brake vehicle deceleration higher than a threshold, the HV stops completely, the transmission state changes to reverse, and the HV moves in reverse for a distance larger than a threshold (e.g. 15 meters). If pattern occurs, it is concluded that the HV is operating on a fast speed road and the notification is generated to notify the operator of the HV of the reverse operation of the vehicle at 540.

A notification message is communicated to the remote transportation system 52 to report the location of the reverse operation at 550 and, optionally, the remote transportation system 52 generates a batch message of the reverse operation to nearby vehicles at 560. Thereafter, the method 500 may end at 570.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method, comprising:
determining, by a processor, reverse direction operation of a first vehicle on a road;
selectively generating, by a processor, notification data based on the reverse operation, map data, camera data, and speed data, wherein the notification data includes information to notify an operator of a second vehicle of the reverse operation; and
selectively generating, by a processor, communication data based on the reverse operation, wherein the communication data includes information to notify at least one of a third vehicle and a remote transportation system of the reverse direction operation.

2. The method of claim 1, further comprising receiving a message indicating reverse operation of an other vehicle, and wherein the determining the reverse direction operation of the first vehicle is based on the message.

3. The method of claim 2, further comprising determining that the other vehicle is traveling on a same road as the second vehicle based on the map data, and wherein the selectively generating the notification data is based on the determining.

4. The method of claim 3, wherein the selectively generating the notification data comprises determining that the other vehicle is traveling ahead of the second vehicle based on the map data, and wherein the selectively generating the notification data is based on the determining.

5. The method of claim 4, wherein the selectively generating the notification data comprises determining that the speed limit of the road is above a threshold.

6. The method of claim 1, further comprising detecting reverse direction operation of the first vehicle based on a transmission state of the first vehicle, and a speed of the first vehicle, and wherein the determining the reverse direction operation is based on the detecting.

7. The method of claim 6, wherein the first vehicle and the second vehicle are the same vehicle.

8. The method of claim 6, further comprising determining that the speed limit of the road is above a threshold, and wherein the determining the reverse direction operation is based on the determining.

9. The method of claim 1, further comprising communicating the communication data to the remote transportation system.

10. The method of claim 1, further comprising communicating the communication data to the third vehicle.

11. A computer implemented system, the system comprising:
a reverse direction detection module that comprises one or more processors configured by programming instructions encoded in non-transitory computer readable media, the reverse direction detection module configured to:
determine reverse direction operation of a first vehicle on a road;
selectively generate notification data based on the reverse operation, map data, camera data, and speed data, wherein the notification data includes information to notify an operator of a second vehicle of the reverse operation; and
selectively generate communication data based on the reverse operation, wherein the communication data includes information to notify at least one of a third vehicle and a remote transportation system of the reverse direction operation.

12. The computer implemented system of claim 11, wherein the reverse direction detection module is further configured to receive a message indicating reverse operation of another vehicle, and wherein the determining the reverse direction operation of the first vehicle is based on the message.

13. The computer implemented system of claim 12, wherein the reverse direction detection module is further configured to determine that the other vehicle is traveling on a same road as the second vehicle based on the map data, and selectively generate the notification data based on the determination.

14. The computer implemented system of claim 13, wherein the reverse direction detection module is configured to selectively generate the notification data by determining that the other vehicle is traveling ahead of the second vehicle based on the map data, and generate the notification data based on the determination.

15. The computer implemented system of claim 14, wherein the reverse direction detection module is configured to selectively generate the notification data by determining that the speed limit of the road is above a threshold, and generate the notification data based on the determination.

16. The computer implemented system of claim 11, wherein the reverse direction detection module is further configured to detect reverse direction operation of the first vehicle based on a transmission state of the first vehicle, and a speed of the first vehicle, and determine the reverse direction operation based on the detection.

17. The computer implemented system of claim 16, wherein the first vehicle and the second vehicle are the same vehicle.

18. The computer implemented system of claim 16, wherein the reverse direction detection module is further configured to determine that the speed limit of the road is above a threshold, and determine the reverse direction operation based on the determination.

19. The computer implemented system of claim 11, wherein the reverse direction detection module is further configured to communicate the communication data to the remote transportation system.

20. The computer implemented system of claim 11, wherein the reverse direction detection module is further configured to communicate the communication data to the third vehicle.
